(19) United States
(12) Patent Application Publication
(10) Pub. No.: US 2021/0084188 A1
(43) Pub. Date: Mar. 18, 2021

(54) IMAGE FORMING APPARATUS AND CONTROL METHOD BY THE SAME

(71) Applicant: TOSHIBA TEC KABUSHIKI KAISHA, Tokyo (JP)

(72) Inventor: Yoshihito HIROE, Tagata Shizuoka (JP)

(73) Assignee: TOSHIBA TEC KABUSHIKI KAISHA, Tokyo (JP)

(21) Appl. No.: 16/575,181

(22) Filed: Sep. 18, 2019

(51) Int. Cl. H04N 1/047; G06T 3/20; H04N 1/409

(52) U.S. Cl. CPC H04N 1/047; H04N 1/4097; G06T 3/20

(57) ABSTRACT

An image forming apparatus disclosed herein includes a scanner configured to read a document to generate an image signal and a processor configured to determine a correction position. The correction position is determined in a main scanning direction based on primary data serving as an average value of pixel values in a sub scanning direction of the image signal. The processor may set a correction parameter based on the determined correction position. The image forming apparatus further includes an image processing circuit configured to correct the image signal based on the correction parameter and an image forming circuit configured to generate image data based on the image signal corrected by the image processing circuit.

### FIELD

Embodiments described herein relate generally to an image forming apparatus and a control method by the same.

### BACKGROUND

An image forming apparatus may execute a print job in response to a printing request, form an image on a print medium, and output the printed print medium. The image forming apparatus may optically read, with a scanner, a document (manuscript) in which characters and illustrations, etc. are printed to generate image data.

The scanner may read the document a plurality of times while changing a positional relationship between an image sensor having a plurality of pixels arranged in a main scanning direction and the document in a sub scanning direction with the image sensor. At this time, a noise signal caused by a foreign matter may be superimposed on an image signal. In other words, there is a possibility that a “streak” resulting from the noise signal extending in the sub scanning direction occurs in the image data due to an object (foreign matter) on an optical path between the pixel of the image sensor of the scanner and the document.

The “streak” in the image data might be weakened through a filtering process, but this method may reduce the resolution of the whole image data and thus worsen the image data quality.

### DESCRIPTION OF THE DRAWINGS

FIG. 1 is a diagram illustrating a configuration of an image forming apparatus according to an embodiment;

FIG. 2 is a diagram illustrating a configuration relating to correction by the image forming apparatus according to the embodiment;

FIG. 3 is a diagram illustrating a correction processing in the image forming apparatus according to the embodiment;

FIG. 4 is a diagram illustrating a document read in the image forming apparatus according to the embodiment;

FIG. 5 is a diagram illustrating the correction processing in the image forming apparatus according to the embodiment;

FIG. 6 is a diagram illustrating the correction processing in the image forming apparatus according to the embodiment; and

FIG. 7 is a diagram illustrating the correction processing in the image forming apparatus according to the embodiment.

### DETAILED DESCRIPTION

In accordance with an embodiment, an image forming apparatus comprises a scanner configured to read a document to generate an image signal; a processor configured to determine a correction position in a main scanning direction based on primary data serving as an average value of pixel values in a sub scanning direction of the image signal, and to set a correction parameter based on the determined correction position; an image processing circuit configured to correct the image signal based on the correction parameter; and an image forming circuit configured to generate image data based on the image signal corrected by the image processing circuit.

Hereinafter, an image forming apparatus and a control method by the same according to an embodiment are described with reference to the accompanying drawings.

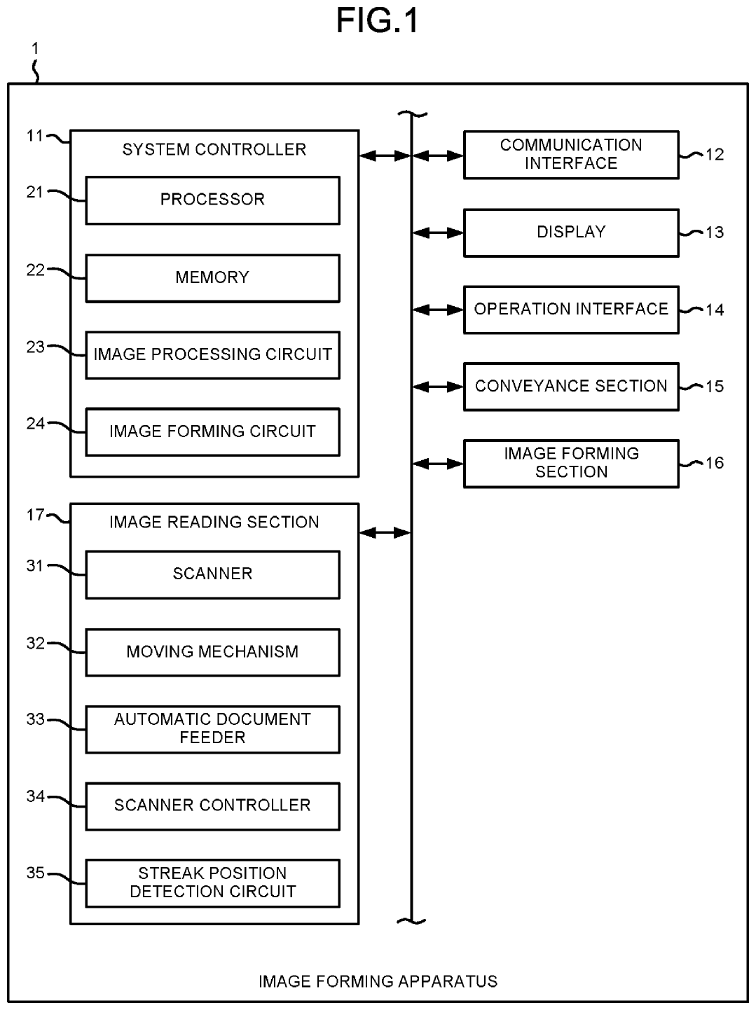

FIG. 1 is a diagram illustrating an image forming apparatus 1 according to the embodiment.

The image forming apparatus 1 is, for example, an MFP (Multi-Function Peripheral) that performs various processing such as image formation while conveying an image receiving medium such as a print medium. The image forming apparatus 1 includes a configuration for forming an image on the print medium with a toner replenished from a toner cartridge. The image forming apparatus 1 includes a configuration for reading an image from the print medium (document) on which the image is printed.

The image forming apparatus 1 is, for example, a multi-function printer (MFP) that performs various processing such as image formation while conveying an image receiving medium such as a print medium. The image forming apparatus 1 is, for example, a solid scanning type printer (e.g., an LED (Light Emitting Diode) printer) that scans an LED array to perform various processing such as image formation while conveying an image receiving medium such as a print medium. The image forming apparatus 1 may be an inkjet type printer (inkjet printer) that scans an inkjet head for ejecting ink, or another type of printer.

The image forming apparatus 1 includes a system controller 11, a communication interface 12, a display 13, an operation interface 14, a conveyance section 15, an image forming section 16 and an image reading section 17. The system controller 11, the communication interface 12, the display 13, the operation interface 14, the conveyance section 15, the image forming section 16 and the image reading section 17 are accommodated in a housing (not shown).

The system controller 11 controls the image forming apparatus 1. The system controller 11 includes, for example, a processor 21, a memory 22, an image processing circuit 23 and an image forming circuit 24.

The processor 21 is an arithmetic element (e.g., a CPU (Central Processing Unit)) that executes an arithmetic processing. Operations of the system controller 11 are mainly controlled by the processor 21. The processor 21 performs various processing based on data such as a program stored in the memory 22. The processor 21 functions as a control section capable of executing various operations by executing programs stored in the memory 22.

The memory 22 stores programs and data used in the programs. The memory 22 temporarily stores data being processed by the processor 21. The memory 22 is a non-volatile memory.

The image processing circuit 23 performs various image processing. The image processing circuit 23 is, for example, a chip of an integrated circuit, and is connected to the processor 21, the memory 22 and the image forming circuit 24. The image processing circuit 23 performs an image processing (e.g., a correction processing) on an image signal serving as a set of density values generated by an image sensor described below, based on a correction parameter described below.

The image forming circuit 24 generates the image data based on the image signal. The image forming circuit 24 is, for example, a chip of an integrated circuit, and is connected to the processor 21, the memory 22 and the image processing circuit 23. The image forming circuit 24 performs a predetermined processing on the image signal to generate the image data having pixel values for each of two-dimensionally arranged coordinates.

The communication interface 12 establishes communication with a client that transmits print data to the image forming apparatus 1 or receives the image data generated in the image forming apparatus 1. The client is, for example, an information processing apparatus such as a personal computer, a smartphone, or a tablet PC (Personal Computer). The communication interface 12 communicates with the client via a network such as a LAN (Local Area Network) connected in a wired manner. The communication interface 12 communicates with the client via a wireless communication network such as a Wi-Fi®, Wi-Fi Direct®, or Bluetooth®.

The display 13 displays a screen according to a video signal input from a display control section such as a system controller 11 or a graphic controller (not shown).

An operating member is a member that generates an operation signal based on an operation. The operation member is, for example, a touch sensor, a numeric key, a power key, a sheet feed key, various function keys or a keyboard. The touch sensor is, for example, a resistance film type touch sensor or a capacitance type touch sensor. The touch sensor acquires information indicating a designated position in a certain area. The touch sensor is integrated with the display 13 described above to form a touch panel to input a signal indicating a touched position on the screen displayed on the display 13 to the system controller 11.

Next, a configuration for forming an image on the print medium is described.

The conveyance section 15 feeds a medium for printing (i.e., a print medium) to the image forming section 16, and then discharges the print medium on which an image is formed by the image forming section 16 from the housing. The conveyance section 15 feeds the print media accommodated in a sheet feed cassette (not shown) for accommodating the print medium, one by one, to the image forming section 16. The conveyance section 15 discharges the print medium on which an image is formed by the image forming section 16 to a sheet discharge tray provided at the outside of the housing.

The image forming section 16 forms an image on the print medium under the control of the system controller 11. The image forming section 16 includes a processing unit, an exposure device, a transfer mechanism and a fixing device.

The processing unit includes a photoconductive drum, an electrostatic charger and a developing device.

The photoconductive drum is provided with a cylindrical drum and a photoconductive layer formed on an outer circumferential surface of the drum. The photoconductive drum rotates at a constant speed by a drive mechanism (not shown).

The electrostatic charger uniformly charges a surface of the photoconductive drum. For example, the electrostatic charger charges the photoconductive drum to a uniform negative potential by applying a voltage to the photoconductive drum with a charging roller.

The developing device attaches the toner to the photoconductive drum. The developing device includes a developer container, a stirring mechanism, a developing roller and a doctor blade.

The developer container receives the toner fed from the toner cartridge to accommodate the toner. A carrier is accommodated in advance in the developer container. The toner fed from the toner cartridge and the carrier are stirred by the stirring mechanism to form a developer in which the toner and the carrier are mixed. The carrier is accommodated in the developer container at the time of manufacture of the developing device.

The developing roller rotates in the developer container to absorb the developer on a surface thereof. A doctor blade is arranged at a predetermined distance from the surface of the developing roller. The doctor blade removes a part of the developer adhering to the surface of the developing roller rotating. In this way, a developer layer having a thickness corresponding to the distance between the doctor blade and the surface of the developing roller is formed on the surface of the developing roller.

The exposure device includes a plurality of light emitting elements. The exposure device forms an electrostatic latent image on the photoconductive drum by irradiating the charged photoconductive drum with light from the light emitting element. The light emitting element is, for example, an LED or the like. One light emitting element emits light to one point on the photoconductive drum. The plurality of light emitting elements is aligned in a main scanning direction parallel to a rotation axis of the photoconductive drum.

The exposure device forms a latent image for one line on the photoconductive drum by irradiating light on the photoconductive drum with a plurality of light emitting elements arranged in the main scanning direction. Furthermore, the exposure device forms electrostatic latent images of plural lines by continuously irradiating the rotating photoconductive drum with the light.

In the above configuration, if the surface of the photoconductive drum charged by the electrostatic charger is irradiated with the light from the exposure device, an electrostatic latent image is formed. If the developer layer formed on the surface of the developing roller approaches the surface of the photoconductive drum, the toner contained in the developer adheres to the electrostatic latent image formed on the surface of the photoconductive drum. In this way, a toner image is formed on the surface of the photoconductive drum.

The transfer mechanism transfers a toner image formed on the surface of the photoconductive drum onto the print medium. The transfer mechanism includes a primary transfer belt, a secondary transfer roller and a plurality of other rollers. The transfer mechanism receives the toner image formed on the surface of the photoconductive drum on the outer circumferential surface of the primary transfer belt. The transfer mechanism conveys the toner image on the outer circumferential surface of the primary transfer belt to a transfer nip at which the secondary transfer roller and the outer circumferential surface of the primary transfer belt closely contact. The transfer mechanism transfers the toner image on the outer circumferential surface of the primary transfer belt onto the print medium by enabling the print medium supplied by the conveyance section 15 to pass through the transfer nip.

The fixing device fixes the toner image transferred onto the print medium to the print medium. The fixing device includes a heating member (heating roller) that applies heat to the print medium, a pressure member (pressure roller) that applies pressure to the print medium, and a heater that heats the heating roller. The pressure roller applies pressure to the heating roller to form a fixing nip at which the pressure roller and the heating roller closely contact therebetween. The fixing device applies heat and pressure to the print medium by enabling the print medium, onto which the toner image is transferred by the transfer mechanism, to pass through the fixing nip. In this way, the fixing device fixes the toner image formed on the print medium. The print medium passing through the fixing nip is discharged to a sheet discharge tray by the conveyance section 15.

Next, a configuration for reading an image from the document is described.

The image reading section 17 optically reads a document serving as the print medium on which characters and illustrations are printed to generate an image signal. The image reading section 17 includes a scanner 31, a moving mechanism 32, an ADF (automatic document feeder) 33, a scanner controller 34 and a streak position detection circuit 35. The image reading section 17 includes a glass plate (not shown). The glass plate functions as a placement surface on which the document is placed.

The scanner 31 reads the document under the control of the scanner controller 34 to generate an image signal. The scanner 31 is arranged in a space on the opposite side of the arrangement surface of the glass plate. The scanner 31 includes an image sensor, illumination, various optical elements, and the like, which are not shown.

An image sensor is an image capturing element in which a plurality of pixels for converting light to an electric signal (image signal) is arranged in a line. The image sensor outputs the generated image signal. The image sensor is, for example, a CCD (Charge Coupled Device), a CMOS (Complementary Metal Oxide Semiconductor), or another image capturing element. A direction in which the pixels of the image sensor are aligned is referred to as the main scanning direction. A direction parallel to the above-mentioned arrangement surface and orthogonal to the main scanning direction is referred to as a sub scanning direction.

The illumination irradiates the document with light through the glass plate. The illumination includes, for example, a light source such as a light emitting diode or a fluorescent lamp, and an optical system for irradiating a reading range of the scanner 31 with light emitted from the light source. The reading range of the scanner 31 is a linear area extending in the main scanning direction on the arrangement surface of the glass plate. The light emitted to the document from the illumination is imaged on a plurality of pixels of the image sensor by various optical elements.

The moving mechanism 32 moves the scanner 31 in the sub scanning direction under the control of the scanner controller 34.

The automatic document feeder 33 conveys the document and enables the scanner 31 to read the document under the control of the scanner controller 34. The automatic document feeder 33 picks up the documents placed in the sheet feed tray one by one. The automatic document feeder 33 conveys the document picked up in the sub scanning direction while enabling the document to closely contact with a position facing the scanner 31 on the arrangement surface of the glass plate to discharge the document.

The scanner controller 34 controls operations of the scanner 31, the moving mechanism 32 and the automatic document feeder 33. Specifically, the scanner controller 34 controls generation and output of the image signal by the scanner 31, movement of the scanner 31 by the moving mechanism 32, and conveyance of the document by the automatic document feeder 33.

The streak position detection circuit 35 performs a predetermined processing based on the image signal generated by the scanner 31. The streak position detection circuit 35 calculates data for detecting a position in the main scanning direction at which a “streak” serving as a noise signal extending in the sub scanning direction occurs due to an object (foreign matter) on an optical path between the pixel of the image sensor of the scanner 31 and the document. The streak position detection circuit 35 transmits a calculation result to the system controller 11.

Next, reading of the document by the image reading section 17 and examples of the image processing circuit 23 and the image forming circuit 24 of the system controller 11 are described.

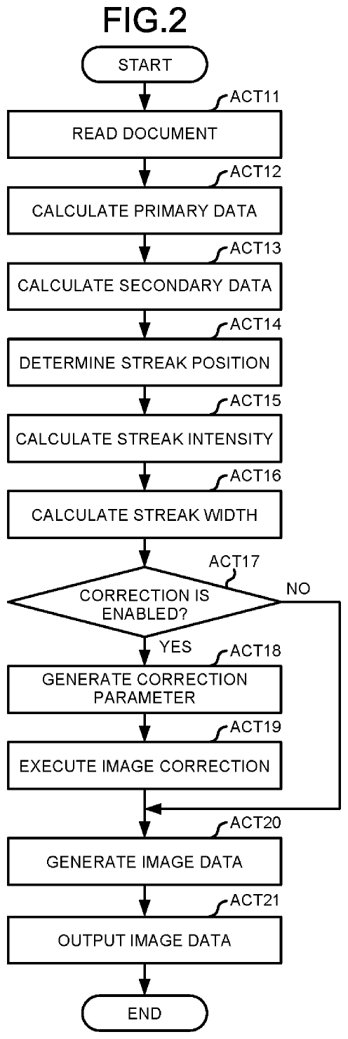

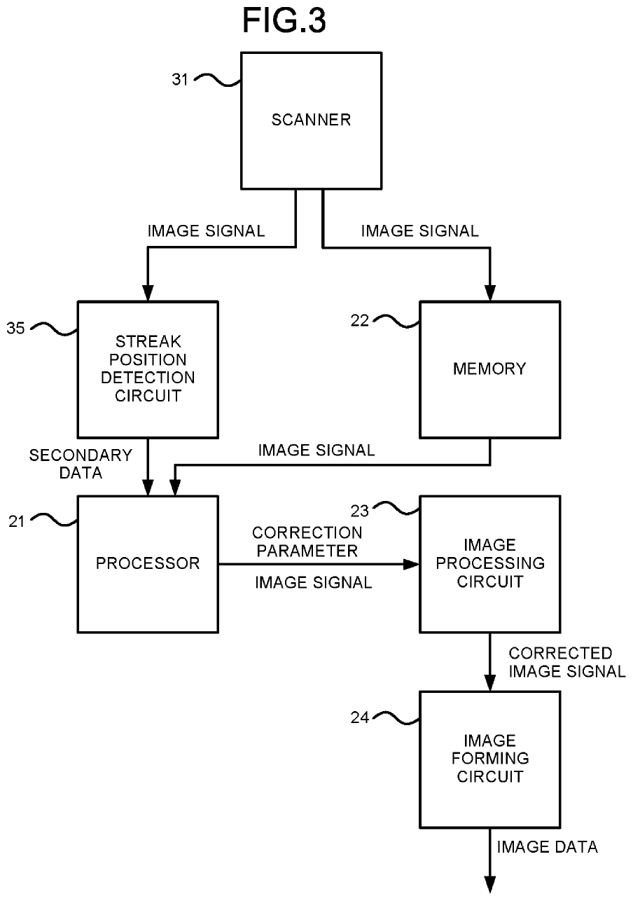

FIG. 2 is a diagram illustrating the reading of the document and a processing on the read image signal. FIG. 3 is a flowchart depicting the reading of the document and the processing on the read image signal.

The scanner controller 34 of the image reading section 17 first determines whether to obtain an image signal with the scanner 31 while conveying the document with the automatic document feeder 33, or to obtain an image signal from the document placed on a glass table while moving the scanner 31 with the moving mechanism 32.

In the case of obtaining the image signal with the scanner 31 while conveying the document with the automatic document feeder 33, the scanner 31 continuously acquires pixel values (density values or luminance values) corresponding to the intensity of light from the document conveyed in the sub scanning direction in the reading range. In this way, the scanner 31 generates the image signal in which the pixel values for each main scanning direction are continuous in the sub scanning direction.

In the case of obtaining the image signal from the document placed on the glass table while moving the scanner 31 with the moving mechanism 32, the scanner 31 is moved by the moving mechanism 32 in the sub scanning direction to continuously acquire pixel values (density values or luminance values) corresponding to the intensity of light from the document. In this way, the scanner 31 obtains the image signal in which the pixel values for each main scanning direction are continuous in the sub scanning direction.

FIG. 2 and FIG. 3 show operations in the case of obtaining the image signal with the scanner 31 while conveying the document with the automatic document feeder 33. In this case, the image forming apparatus 1 executes the processing shown in FIG. 2 and FIG. 3 for each page of the document.

First, the image reading section 17 reads the document (Act 11). The scanner 31 stores the image signal in the memory 22 of the system controller 11 or a page memory (not shown), as shown in FIG. 3. Furthermore, the scanner 31 transmits the image signal to the streak position detection circuit 35, as shown in FIG. 3.

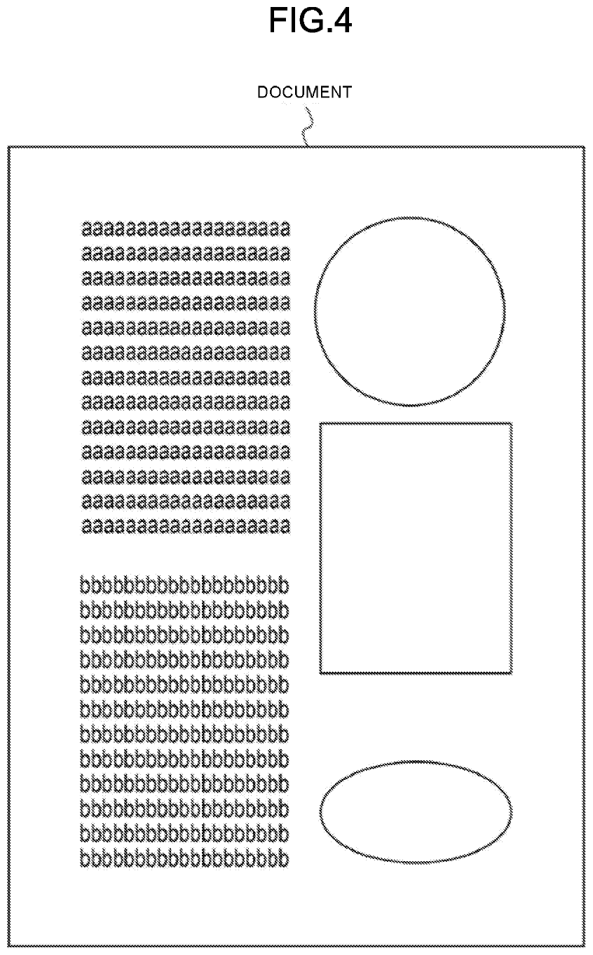

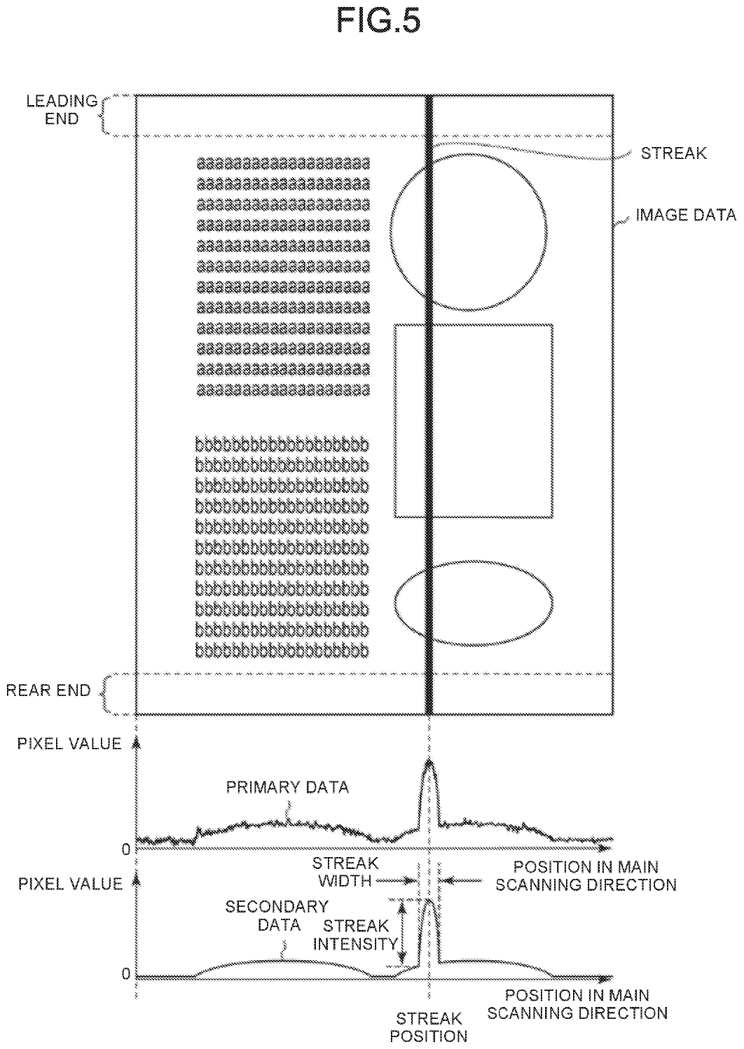

FIG. 4 is a diagram illustrating a document. FIG. 5 is a diagram illustrating the image data generated based on the image signal of the document in which a streak occurs. According to the configuration as described above, if an object (foreign matter) is present on the optical path between the pixel of the image sensor of the scanner 31 and the document, the “streak” serving as a noise signal extending in the sub scanning direction occurs in the image signal and the image data.

The streak position detection circuit 35 calculates the primary data based on the input image signal (Act 12). The primary data is, for example, an average value of pixel values in the sub scanning direction of the image signal. The streak position detection circuit 35 calculates an average value of pixel values in the sub scanning direction for each pixel aligned in the main scanning direction based on the input the image signal. For example, the streak position detection circuit 35 calculates an average value of pixel values over the entire area in the sub scanning direction.

Next, the streak position detection circuit 35 calculates secondary data based on the primary data (Act 13). The secondary data is obtained by reducing the noise in the primary data through a filtering processing. The filtering processing is, for example, a processing in which a low pass filter and a high pass filter are combined. The filtering processing may be any processing as long as it can emphasize the streak.

Through the above processing, as shown in FIG. 5, the streak position detection circuit 35 calculates the primary data based on the input image signal, and the secondary data in which the streak in the primary data is emphasized can be obtained. The streak position detection circuit 35 transmits the secondary data to the processor 21. The streak position detection circuit 35 transmits an interrupt signal to the processor 21 together with the secondary data. In this way, the processor 21 can preferentially execute the processing based on the secondary data.

The processor 21 determines a streak position based on the secondary data (Act 14). For example, the processor 21 determines a position where a peak is present in the secondary data as the streak position. For example, the processor 21 determines, as the streak position, the position of a peak of a mountain shape in which a peak having a predetermined pixel value or more is present. The processor 21 may determine one or more streak positions.

The processor 21 calculates a streak intensity based on the secondary data (Act 15). For example, the processor 21 calculates the streak intensity based on a difference between the pixel value in the vicinity of the streak position and the pixel value at the streak position.

The processor 21 calculates a streak width based on the secondary data (Act 16). For example, the processor 21 calculates the streak width based on a change corresponding to the main scanning direction in the pixel value in the vicinity of the streak position.

The processor 21 determines the streak position, the streak intensity and the streak width by using either the interrupt signal supplied from the streak position detection circuit 35 or the termination of input of the image signal for one page to the memory 22 as a trigger.

Features manifested in the secondary data due to the streak become features fixed to some extent. Therefore, the processor 21 may compare a shape pattern generated in advance with the secondary data to determine the streak position, the streak intensity and the streak width based on a similarity between the shape pattern and the secondary data.

The processor 21 determines whether or not the correction of the image signal by the image processing circuit 23 is enabled based on the streak position, the streak intensity and the streak width (Act 17). For example, the processor 21 determines that the correction is disabled if the streak width is equal to or greater than a predetermined width.

If it is determined that the correction is enabled (Yes in Act 17), the processor 21 generates a correction parameter to be used by the image processing circuit 23 (Act 18). The correction parameter indicates a correction position in the main scanning direction and a correction intensity.

The processor 21 executes the correction processing by reading out the image signal from the memory 22 and inputting the image signal read out and the correction parameter to the image processing circuit 23 (Act 19). The image processing circuit 23 corrects the pixel value at the correction position of the image signal according to the correction intensity based on the correction parameter. The processor 21 determines the correction position based on the streak position and the streak width. The processor 21 determines the correction intensity based on the streak intensity. The processor 21 generates the correction parameter to suppress an influence of the streak generated due to the foreign matter. The image processing circuit 23 transmits the corrected image signal to the image forming circuit 24.

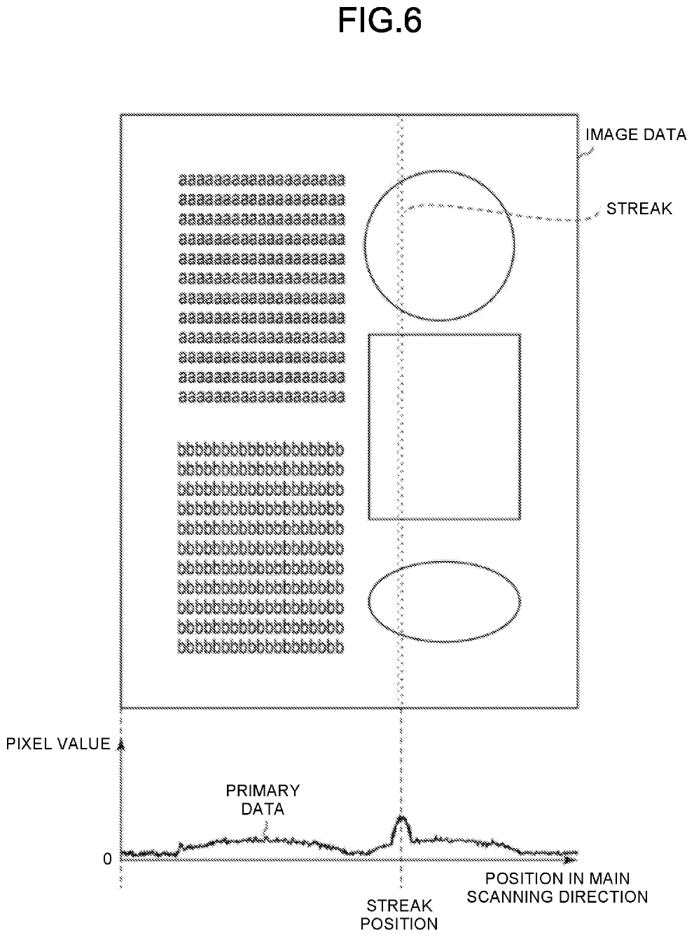

FIG. 6 is a diagram illustrating the image data generated based on the corrected image signal. As shown in FIG. 6, the difference between the average value of the pixel values at the position at which the streak occurs and the average value of the pixel values in the vicinity thereof is suppressed. In this way, in the image data, the streak can be made inconspicuous while maintaining the sense of resolution at a position other than the streak position.

The image forming circuit 24 quantizes the image signal corrected by the image processing circuit 23 into digital data (i.e., image data) in a predetermined format to generate the image data (Act 20). The image forming circuit 24 outputs the image data (Act 21), and then terminates the processing in FIG. 2.

In the above-mentioned example, the processor 21 respectively calculates the streak position, the streak intensity and the streak width, but it is not limited thereto. The streak position detection circuit 35 may calculate the streak position, the streak intensity and the streak width, respectively, and transmit the calculated values to the processor 21 of the system controller 11. The streak position detection circuit 35 may be software. Specifically, the function of the streak position detection circuit 35 may be performed by the processor 21 executing programs. The functions of the image processing circuit 23 and the image forming circuit 24 may be performed by the processor 21 executing programs.

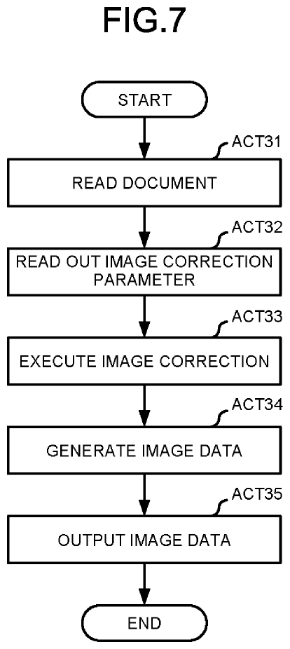

FIG. 7 is a diagram illustrating the reading of the document and the processing on the read image signal. FIG. 7 shows operations in the case of obtaining the image signal with the scanner 31 while moving the scanner 31 with the moving mechanism 32. Specifically, FIG. 7 shows a processing for the document placed on the glass table. In this case, the image forming apparatus 1 performs a correction processing based on a correction parameter generated in advance and stored in the memory 22. Specifically, the image forming apparatus 1 performs a correction processing based on a fixed correction parameter generated in advance and stored in the memory 22 based on the image signal obtained by the scanner 31, instead of the operation of determining the correction position and the correction parameter for each page as shown in FIG. 2. In this case, the correction parameter is generated, for example, in an operation mode such as a maintenance and inspection mode. The image forming apparatus 1 may generate the correction parameter and store it in the memory 22 at any timing before the document is not placed on the glass table.

First, the image reading section 17 reads the document (Act 31). The scanner 31 stores the image signal in the memory 22 of the system controller 11.

The processor 21 reads out the correction parameter from the memory 22 (Act 32). Furthermore, the processor 21 executes the correction processing by reading out the image signal from the memory 22 and inputting the image signal read out and the correction parameter to the image processing circuit 23 (Act 33). The image processing circuit 23 corrects the pixel value at the correction position of the image signal according to the correction intensity based on the correction parameter.

The image forming circuit 24 quantizes the image signal corrected by the image processing circuit 23 into digital data (i.e., image data) in a predetermined format to generate the image data (Act 34). The image forming circuit 24 outputs the image data (Act 35), and then terminates the processing in FIG. 7.

As described above, the image forming apparatus 1 includes the scanner 31 for reading the document to generate the image signal, the image processing circuit 23 for correcting the image signal based on the correction parameter, the image forming circuit 24 for generating the image data based on the image signal corrected by the image processing circuit 23, and the processor 21. The processor 21 determines the correction position in the main scanning direction based on the primary data serving as the average value of pixel values in the sub scanning direction of the image signal, and sets the correction parameter based on the determined correction position. By performing the correction processing for correcting the image signal based on the correction parameter set in this way, the influence of the noise can be suppressed while maintaining the sense of resolution at a position other than the correction position. As a result, the image forming apparatus 1 can make the streak, which is the noise signal extending in the sub scanning direction and caused by the object (foreign matter) on the optical path between the pixel of the image sensor of the scanner 31 and the document, inconspicuous.

In the case of obtaining the image signal with the scanner 31 while conveying the document with the automatic document feeder 33, there is a possibility that the foreign matter may move in the main scanning direction as the document is conveyed. In such a case, there is a possibility that the streak occurs at a different position for each page of the document. Therefore, the processor 21 determines the correction position for each page of the document. In this way, the correction processing can be appropriately performed even if the foreign matter moves as described above.

In the above embodiment, the streak position detection circuit 35 calculates the average value of pixel values over the entire area in the sub scanning direction, but it is not limited thereto. The streak position detection circuit 35 may calculate an average value of pixel values for each predetermined area in the sub scanning direction.

As shown in FIG. 4 and FIG. 5, there is a high possibility that no image is formed at a leading end and a rear end of the document. On the other hand, at a position close to the center of the document, there is a possibility that a ruled line or the like is present, and in this case, if the average value of pixel values over the entire area in the sub scanning direction is calculated, there is a possibility that the determination of the streak position, the calculation of the streak intensity and the calculation of the streak width are not performed properly.

Therefore, the streak position detection circuit 35 may calculate the primary data in areas at the leading end and the rear end of the document, perform the filtering processing on the primary data, and output the secondary data. In this case, the processor 21 determines the streak position, calculates the streak intensity, and calculates the streak width from the secondary data generated based on the primary data relating to the leading end and the rear end of the document. With such a configuration, the image signal can be corrected while the influence on the image of the document can be suppressed.

The streak position detection circuit 35 may calculate the primary data based on image signals of both areas at the leading end and the rear end of the document. In this case, the processor 21 compares the primary data calculated based on the image signal of the leading end of the document with the primary data calculated based on the image signal of the area at the rear end thereof. The processor 21 may determine that the correction processing by the image processing circuit 23 is disabled if the two pieces of primary data do not match.

The processor 21 may determine the streak position in the main scanning direction based on the primary data calculated based on an image signal of either the area at the leading end or the area at the rear end of the document.

The functions described in the above-described embodiments can be performed not only by using hardware but also by a computer reading programs in which the functions are recorded through software. The functions may be performed by selecting either software or hardware as appropriate.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
a scanner configured to read a document to generate an image signal;
a processor configured to determine a correction position in a main scanning direction based on primary data determined as an average value of pixel values of the image signal in a sub scanning direction of the image signal, and to set a correction parameter based on the determined correction position;
an image processing circuit configured to correct the image signal based on the correction parameter; and
an image forming circuit configured to generate image data based on the image signal corrected by the image processing circuit.

2. The image forming apparatus according to claim 1, wherein
the processor is configured to determine the correction position based on secondary data obtained by performing filtering processing on the primary data to reduce noise.

3. The image forming apparatus according to claim 2, wherein
the processor is configured to determine, based on the secondary data, a position in the main scanning direction of a streak occurring due to an object on an optical path between an image sensor of the scanner and the document, and to determine the correction position based on the position in the main scanning direction of the streak.

4. The image forming apparatus according to claim 1, wherein
the processor is configured to determine the correction position for each page of the document.

5. The image forming apparatus according to claim 2, wherein
the processor is configured to determine a correction intensity for the image signal based on the secondary data, and to set the correction parameter based on the correction intensity and the correction position.

6. The image forming apparatus according to claim 2, wherein
the processor is configured to determine a streak width based on the secondary data, and to determine the correction position based on the streak width.

7. The image forming apparatus according to claim 1, wherein
the processor is configured to determine the correction position based on the image signal of either or both of areas at a leading end and a rear end of the document.

8. The image forming apparatus according to claim 7, wherein
the processor is configured to determine that correction of the image signal by the image processing circuit is disabled if the primary data calculated based on the image signal at the leading end of the document and the primary data calculated based on the image signal at the area at the rear end do not match.

9. A method for correcting image signals, the method comprising:
receiving an image signal from a scanner, the image signal having data acquired in a main scanning direction of the scanner;
determining a correction position of the image signal in the main scanning direction based on primary data serving as an average value of pixel values in a sub scanning direction of the image signal; and
setting a correction parameter based on the determined correction position.

10. The method of claim 9, further comprising determining secondary data based on the primary data by reducing noise in the primary data through filtering processing.

11. The method of claim 10, wherein determining the correction position of the image signal in the main scanning direction is based on the secondary data.

12. The method of claim 10, further comprising calculating a correction intensity based on the secondary data, the correction intensity indicating a difference between pixel values near the correction position and pixel values at the correction position.

13. The method of claim 12, wherein setting the correction parameter is based on the correction intensity.

14. The method of claim 10, further comprising calculating a correction width based on the secondary data, the correction width indicating a change corresponding to the main scanning direction in pixel values near the correction position.

15. The method of claim 14, wherein setting the correction parameter is based on the correction width.

16. The method of claim 15, further comprising executing an image correction based on the correction parameter, and generating image data of a corrected image signal.

17. The method of claim 16, further comprising outputting the corrected image signal to form an image.

18. A method for removing a streak defect during scanning of an image, the method comprising:
scanning, in a scanner, an original image to generate a set of image signals;
determining a defect in the scanner based on the set of image signals;
correcting the defect in the set of image signals by editing data associated with the defect;
generating a corrected set of image signals; and
outputting image data of the original image without the defect in the scanner.

19. The method of claim 18, wherein determining the defect in the scanner based on the set of image signals includes:
calculating primary data of the set of image signals, the primary data indicating an average of pixel values in a sub scanning direction for each pixel aligned in a main scanning direction of the set of image signals;
calculating secondary data based on the primary data by reducing noise in the primary data through filtering processing; and
determining a defect position based on the secondary data, the defect position indicating a peak in the secondary data.

20. The method of claim 19, wherein determining the defect in the scanner based on the set of image signals further includes:
calculating a defect intensity based on the secondary data, the defect intensity indicating a difference between pixel values adjacent the defect position and a pixel value at the defect position;
calculating a defect width based on the secondary data, the defect width indicating a change corresponding to pixel values along the main scanning direction adjacent the defect position; and
generating correction parameters based on the defect position, the defect intensity, and the defect width to form the corrected set of image signals.
